(19) United States
(12) Patent Application Publication
(10) Pub. No.: US 2018/0276348 A1
(43) Pub. Date: Sep. 27, 2018

(54) PRODUCING CHEMICAL FORMULATIONS WITH COGNITIVE COMPUTING

(71) Applicant: HALLIBURTON ENERGY SERVICES, INC., Houston, TX (US)

(72) Inventors: Dale E. JAMISON, Humble, TX (US); Paul H. MORAN, Missouri City, TX (US); Robert Lynn WILLIAMS, Spring, TX (US); Amir BAR, Houston, TX (US)

(73) Assignee: HALLIBURTON ENERGY SERVICES, INC., Houston, TX (US)

(21) Appl. No.: 15/756,121

(22) PCT Filed: Oct. 30, 2015
(86) PCT No.: PCT/US2015/058456

§ 371 Date: Feb. 28, 2018

(51) Int. Cl. G06F 19/00; G06N 3/08

(52) U.S. Cl. CPC G06F 19/707; G06N 3/088

(57) ABSTRACT

A cognitive computing system for producing chemical formulations, in some embodiments, comprises: neurosynaptic processing logic; and one or more information repositories accessible to the neurosynaptic processing logic, said one or more repositories storing resources, wherein the neurosynaptic processing logic determines a first chemical formulation to achieve a target and to satisfy one or more constraints, produces and tests said first chemical formulation, and analyzes the results of the test using said resources to determine a second chemical formulation, wherein the second chemical formulation more closely achieves the target and satisfies the one or more constraints than the first chemical formulation.

### BACKGROUND

Computer scientists and engineers have long tried to create computers that mimic the mammalian brain. Such efforts have met with limited success. While the brain contains a vast, complex and efficient network of neurons that operate in parallel and communicate with each other via dendrites, axons and synapses, virtually all computers to date employ the traditional von Neumann architecture and thus contain some variation of a basic set of components (e.g., a central processing unit, registers, a memory to store data and instructions, external mass storage, and input/output devices). Due at least in part to this relatively simple architecture, von Neumann computers are adept at performing calculations and following specific, deterministic instructions, but—in contrast to the biological brain—they are generally inefficient; they adapt poorly to new, unfamiliar and probabilistic situations; and they are unable to learn, think, and handle data that is vague, noisy, or otherwise imprecise. These shortcomings substantially limit the traditional von Neumann computer's ability to make meaningful contributions in industries that produce chemical formulations—for example, the oil and gas industry, the petrochemical industry and the pharmaceutical industry.

In such industries there is a heavily reliance on human effort, which exacerbates the inefficiencies introduced by the von Neumann computer. Typically, in a chemical development environment (e.g., a research and development laboratory), chemists and engineers perform a set of experiments involving various chemical formulations and reactions in an effort to produce a chemical formulation that meets one or more performance targets while honoring one or more predetermined constraints (e.g., budget limitations). This process is typically iterative, with new information obtained from each round of experiments being used in subsequent experiments to further optimize the chemical being formulated. Such processes are labor-intensive and inefficient, often requiring hundreds or even thousands of man-hours to produce a chemical formulation with the desired characteristics.

### BRIEF DESCRIPTION OF THE DRAWINGS

Accordingly, there are disclosed in the drawings and in the following description cognitive computing systems and methods for producing and enhancing chemical formulations. In the drawings:

FIG. 1A is an illustration of a pair of biological neurons communicating via a synapse.

FIG. 1B is a mathematical representation of an electronic neuron.

FIG. 1C is a schematic diagram of a neurosynaptic tile for use in a cognitive computer.

FIG. 1D is a schematic diagram of a circuit that embodies an electronic synapse.

FIG. 1E is a schematic diagram of an electronic neuron.

FIG. 1F is a block diagram of an electronic neuron spiking logic.

FIG. 2 is a schematic diagram of a neurosynaptic core for use in a cognitive computer.

FIG. 3 is a schematic diagram of a multi-core neurosynaptic chip for use in a cognitive computer.

FIG. 4 is a detailed schematic diagram of a dual-core neurosynaptic chip for use in a cognitive computer.

FIGS. 5 and 6 are conceptual diagrams of scalable corelets used for programming neurosynaptic processing logic.

FIG. 7 is a block diagram of a cognitive computing system that has access to multiple information repositories.

FIG. 8 is a block diagram of a cognitive computing system controlling a chemical formulation system and a field implementation system.

FIG. 9 is a flow diagram of a method used to produce and enhance chemical formulations.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are methods and systems for producing and enhancing chemical formulations using cognitive computers. Cognitive computers—also known by numerous similar terms, including artificial neural networks, neuromorphic and synaptronic systems, and, in this disclosure, neurosynaptic systems—are modeled after the mammalian brain. In contrast to traditional von Neumann architectures, neurosynaptic systems include extensive networks of electronic neurons and cores operating in parallel with each other. These electronic neurons function in a manner similar to that in which biological neurons function, and they couple to electronic dendrites, axons and synapses that function like biological dendrites, axons and synapses. By modeling processing logic after the biological brain in this manner, cognitive computers—unlike von Neumann machines—are able to support complex cognitive algorithms that replicate the numerous advantages of the biological brain, such as adaptability to ambiguous, unpredictable and constantly changing situations and settings; the ability to understand context (e.g., meaning, time, location, tasks, goals); and the ability to learn new concepts.

Key among these advantages is the ability to learn, because learning fundamentally drives the cognitive computer's behavior. In the cognitive computer—just as with biological neural networks—learning (e.g., Hebbian learning) occurs due to changes in the electronic neuron and synapses as a result of prior experiences (e.g., a training session with a human user) or new information. These changes, described below, affect the cognitive computer's future behavior. In a simple example, a cognitive computer robot with no prior experience or software instructions with respect to coffee preparation can be introduced to a kitchen, shown what a bag of ground coffee beans looks like, and shown how to use a coffee machine. After the robot is trained, it will be able to locate materials and make the cup of coffee on its own, without human assistance. Alternatively, the cognitive computer robot may simply be asked to make a cup of coffee without being trained to do so. The computer may access information repositories via a network connection (e.g., the Internet) and learn what a cup is, what ground coffee beans are, what they look like and where they are typically found, and how to use a coffee machine—for example, by means of a YOUTUBE® video. A cognitive computer robot that has learned to make coffee in other settings in the past may engage in a conversation with the user to ask a series of specific questions, such as to inquire about the locations of a mug, ground coffee beans, water, the coffee machine, and whether the user likes sugar and cream with his coffee. If, while preparing the coffee, a wet coffee mug slips from the robot's hand and falls to the floor, the robot may infer that a wet mug is susceptible to slipping and it may grasp a wet mug a different way the next time it brews a cup of coffee.

The marriage between neurosynaptic architecture and cognitive algorithms represents the next step beyond artificial intelligence and can prove especially useful in the oil and gas industry. This disclosure describes the use of neurosynaptic technology (and associated cognitive algorithms) to intelligently design, produce and enhance chemical formulations in various contexts—for example, in the oil and gas, petrochemical and pharmaceutical industries. In particular, a cognitive computer implementing neurosynaptic technology leverages access to various resources—such as books, studies, papers, databases, trade journals, chemistry models and formulas, presentations, and the like—to iteratively determine a chemical formulation that is most likely to achieve one or more specified targets while satisfying one or more specified constraints. The cognitive computer performs these actions intelligently, probabilistically and with minimal or no human assistance using its neurosynaptic architecture and cognitive algorithms.

More specifically, a cognitive computer engaged in producing chemical formulations is provided with information about a desired target (or, in some embodiments, multiple desired targets). The target is typically described in terms of the desired function of the chemical formulation. For example and without limitation, the target may be a drilling fluid that reduces non-productive time (NPT) below a given threshold in a given well. The cognitive computer would be provided with this target information in as much detail as possible or practical. In some embodiments, the cognitive computer obtains some of this information on its own through the various resources to which it has access. The cognitive computer may also be provided with one or more constraints that must be satisfied by a particular chemical formulation that purports to meet the target. These constraints vary widely and may include, without limitation, chemical properties (e.g., corrosion resistance, pH, reactivity, surface tension, heat of combustion, enthalpy of formation, toxicity, chemical stability in a given environment, flammability, oxidation state(s)); rheology; time-dependent rheology; mixture of compositions; salinity; turbidity; solubility; filtration characteristics; chemical/geometric structure; cost to manufacture; time to manufacture, and the like. The specific types of constraints provided to the cognitive computer may vary depending on the particular application or industry in question. The constraints provided for drilling fluid, for instance, may differ from the constraints provided for a pharmaceutical compound.

The cognitive computer uses the target(s) and constraint(s) to identify resources that may be helpful in designing a first chemical formulation for production and in determining how best to produce the first chemical formulation. For example, given a set of target(s) and constraint(s), the cognitive computer may access textbooks, technical journals, chemistry databases, the periodic table of elements, chemical materials pricing guides, and numerous other relevant resources to design a chemical formulation that would achieve the target while honoring the constraints. After designing the first chemical formulation, the cognitive computer produces the formulation. Specifically, the cognitive computer couples to or comprises a hardware control system. The hardware control system controls the various components of a chemical production system. For instance, the cognitive computer—via the hardware control system—controls chemical and material storage queues, mixing systems, testing systems, conditioning systems, cleaning and disposal systems, etc. In this way, the cognitive computer causes the hardware control system to use these various components of the chemical production system to produce and test the first chemical formulation. The specific chemical and material combinations, preparations and tests that are performed by the chemical production system are determined by the cognitive computer as it analyzes the target(s), constraint(s) and resources to which it has access. Alternatively or in addition, the cognitive computer may have received training (e.g., from a human or other cognitive computer) that aids the cognitive computer in identifying and producing the first chemical formulation. Similarly, the cognitive computer may have learned from similar experiences in the past and it may use these experiences to help design and produce the first chemical formulation.

Once the cognitive computer produces the first chemical formulation, it is tested to determine one or more parameters associated with that formulation. The specific parameters tested vary and the scope of disclosure is not limited to any particular set of parameters to be tested. Based on the test results, the cognitive computer may take any number of actions. For example, in some embodiments, the cognitive computer may use the results to refine the chemical formulation, thus determining a second chemical formulation that may be produced. In such embodiments, the cognitive computer causes the chemical production system to produce the second chemical formulation. The second chemical formulation, in most cases, will be closer to achieving the target(s) and/or desired constraint(s) than the first chemical formulation, and this will generally be true for each successive iteration. This iterative process may be performed any suitable number of times. In other embodiments, the cognitive computer develops a field implementation recommendation—for instance, in the case of drilling fluid, a recommendation as to precisely how the first chemical formulation (or a modified version thereof) should be implemented in a drilling operation. The cognitive computer may unilaterally or upon command execute the field implementation recommendation—in the foregoing example, by adjusting the dosing systems for the drilling fluid in a particular drilling operation. The application in which the field implementation recommendation is implemented may then be tested as appropriate or desired, and the results of such testing may be used to further refine the first chemical formulation (or the modified version thereof that was used and tested in the field). In still other embodiments, both of the foregoing embodiments' processes may be performed.

The cognitive computer is able to discuss the foregoing processes, results and recommendations with a human user or other cognitive computer. The cognitive computer can develop arguments using its probabilistic design to support its recommendations and to respond to interrogation by other users or cognitive computers. By discussing the experiments, results and recommendations with human users and/or other cognitive computers, the cognitive computer is able to intelligently design, develop and defend its chemical formulations.

In this way, the cognitive computer not only determines the design of chemistry experiments, but it also manages the associated experimentation (e.g., mixing/reacting, testing, conditioning) as well. Most or all mechanical processes associated with chemical development and production are managed by the cognitive computer. The cognitive computer is retrospective in that it iteratively evaluates its own prior performance in light of the target(s), constraint(s) and/or resources to improve performance in the next iteration of chemical development.

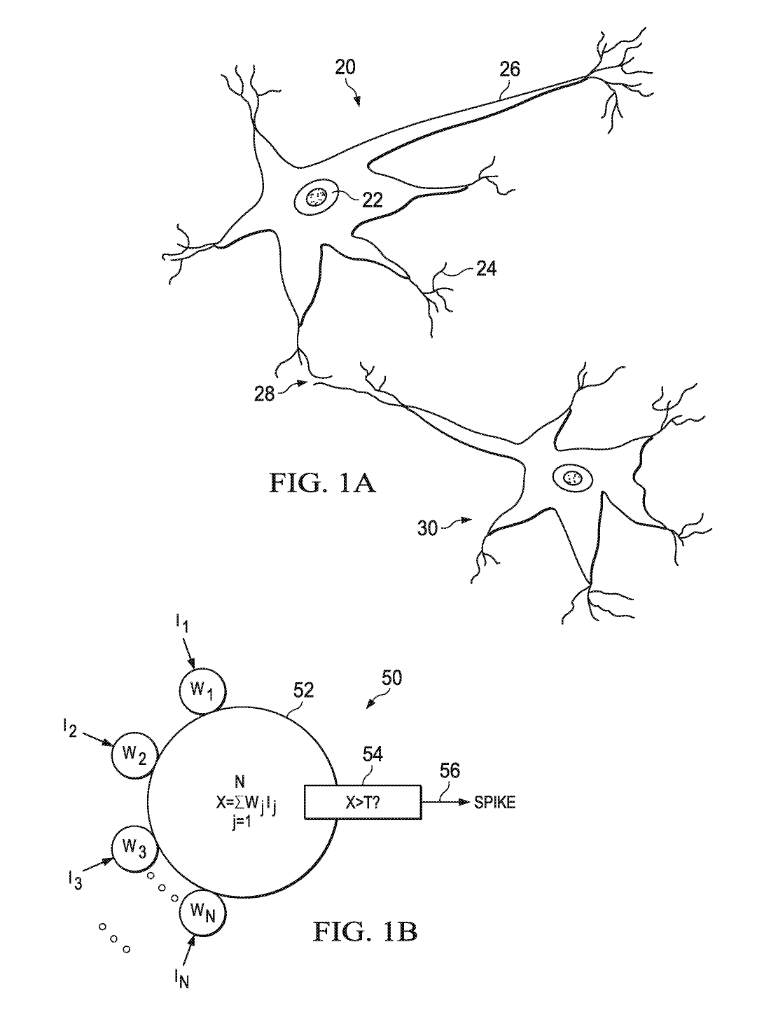

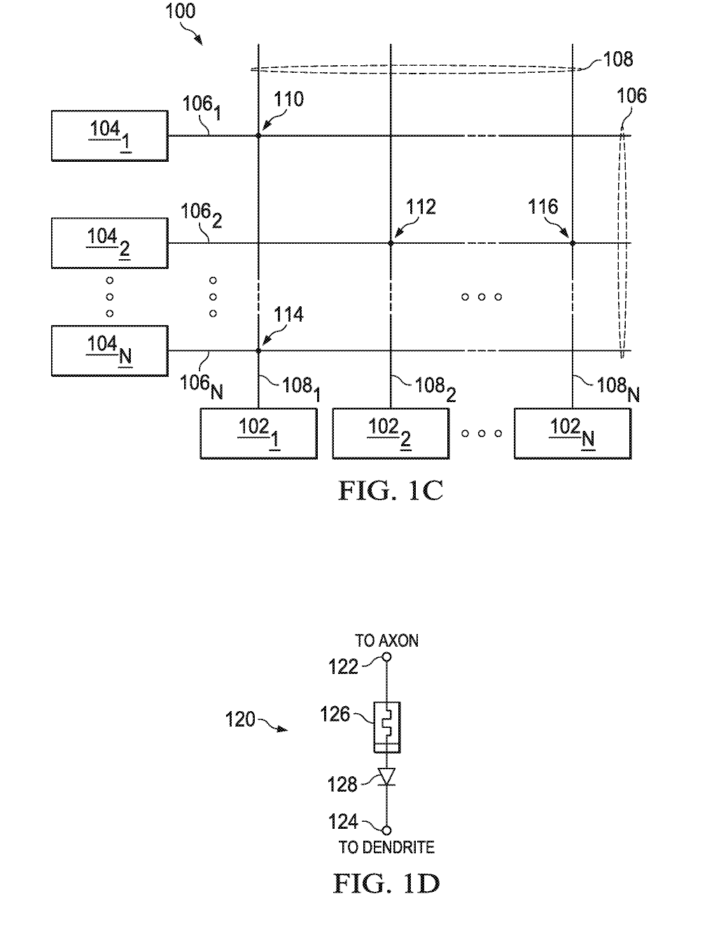

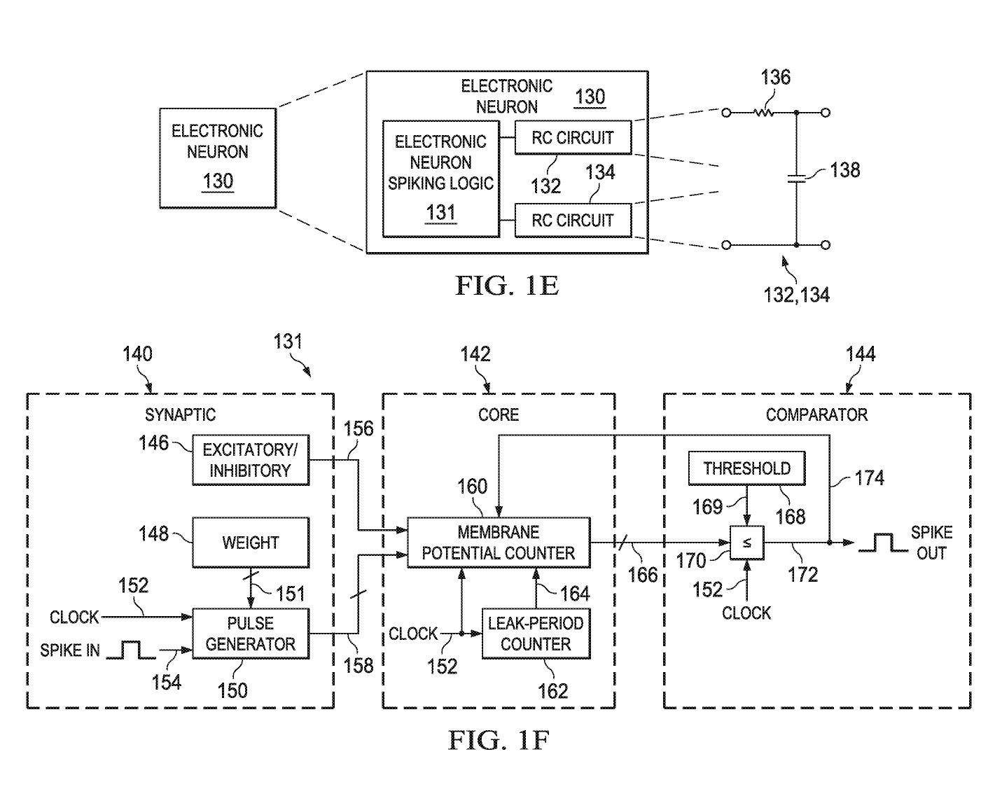

FIG. 1A is an illustration of a pair of biological neurons communicating via a synapse. Specifically, neuron 20 includes a nucleus 22, dendrites 24, an axon 26 and a synapse 28 by which it communicates with another neuron 30. The dendrites 24 serves as inputs to the neuron 20, while the axon 26 serves as an output from the neuron 20. The synapse 28 is the space between an axon of neuron 30 and a dendrite 24 of neuron 20, and it enables the neuron 30 to output information to the neuron 20 using neurotransmitters (e.g., dopamine, norepinephrine). The neuron 20 receives input from numerous neurons (not specifically shown) in addition to the neuron 30. Each of these inputs impacts the neuron 20 in different ways. Some of these neurons provide excitatory signals to the neuron 20, while other neurons provide inhibitory signals to the neuron 20. Excitatory signals push the membrane potential (i.e., the voltage difference between the neuron and the space surrounding the neuron, typically about −70 mV) toward a threshold value which, if exceeded, results in an action potential (or “spiking,” which is the transmission of a pulse) of the neuron 20, and inhibitory signals pull the membrane potential of the neuron 20 away from this threshold. The repeated excitation or inhibition the neuron 20 through these different input pathways results in learning. Stated another way, if a particular input to a neuron repeatedly and persistently causes that neuron to fire, a metabolic change occurs in the synapse associated with that input axon to reduce the resistance in the synapse. This phenomenon is known as the Hebbian learning rule. In a more specific version of Hebbian learning, called spike-timing-dependent plasticity (STDP), repeated presynaptic spike arrival a few milliseconds before postsynaptic action potentials leads to long-term potentiation of that synapse, whereas repeated presynaptic spike arrival a few milliseconds after postsynaptic action potentials leads to long-term depression of the same synapse. STDP is thus a form of neuroplasticity, in which synaptic changes occur due to changes in behavior, environment, neural processes, thinking, and emotions.

FIG. 1B is a mathematical representation of an electronic neuron 50 that mimics the behavior of a biological neuron. Specifically, the electronic neuron 50 includes a nucleus 52 that has multiple inputs I₁, I₂, . . . , I_{N}, and these inputs are associated with weights W₁, W₂, . . . , W_{N}, respectively. The weight associated with an input dictates the impact that input will have upon the neuron 50 and, more specifically, on the electronic neuron's mathematical equivalent of a biological membrane potential (which, for purposes of this discussion, will still be referred to as a membrane potential). The summation of the weighted inputs produces a membrane potential x, which causes a spike 56 if the potential x exceeds a threshold value T (numeral 54). Similar to Hebbian learning, repeated and persistent signals from a particular input to the electronic neuron 50 that causes the neuron to spike results in a shift in the magnitudes of weights W₁, W₂, . . . , W_{N} to increase the weight associated with that particular input.

FIG. 1C is a schematic diagram of a neurosynaptic tile 100 for use in a cognitive computer. The neurosynaptic tile 100 includes a plurality of electronic neurons 102₁, 102₂, . . . , 102_{N}. The tile 100 further includes a plurality of electronic neurons 104₁, 104₂, . . . , 104_{N}. Each of the neurons 104₁, 104₂, . . . , 104_{N} couples to an axon 106₁, 106₂, . . . , 106_{N} (generally indicated by numeral 106), respectively. Similarly, each of the neurons 102₁, 102₂, . . . , 102_{N} couples to a dendrite 108₁, 108₂, . . . , 108_{N} (generally indicated by numeral 108), respectively. The axons 106 and dendrites 108 couple to each other in predetermined locations. For example, axon 106₁ couples to dendrite 108₁ at an electronic synapse 110; axon 106₂ couples to dendrites 108₂, 108_{N} at synapses 112, 116, respectively; and axon 106_{N} couples to dendrite 108₁ at synapse 114. In operation, when any of the membrane potentials of the electronic neurons 104₁, 104₂, . . . , 104_{N} reaches or exceeds a threshold value, that neuron(s) fires on the corresponding axon(s) 106. The dendrites 108 to which the firing axons 106 couple receive the spikes and provide them to the neurons 102₁, 102₂, . . . , 102_{N}.

As explained above with respect to FIG. 1B, an electronic neuron may ascribe different weights to each input provided to that neuron. The same is true for the electronic neurons 102₁, 102₂, . . . , 102_{N} and 104₁, 104₂, . . . , 104_{N}. Thus, for example, the dendrite 108₁, which corresponds to electronic neuron 102₁, couples to axons 106₁, 106_{N} at synapses 110, 114, respectively, and the electronic neuron 102₁ ascribes different weights to the inputs from dendrites 106₁ and 106_{N}. If a greater weight is ascribed to dendrite 106₁, the excitatory or inhibitory signal provided by that dendrite receives greater consideration toward the calculation of the membrane potential of the neuron 102₁. Similarly, if a greater weight is ascribed to dendrite 106_{N}, the excitatory or inhibitory signal provided by that dendrite receives greater consideration toward the calculation of the membrane potential of the neuron 102₁. If the summation of the weighted signals received from the dendrites 106₁ and 106_{N} exceeds the threshold of the neuron 102₁, the neuron 102₁ spikes on its axon (not specifically shown). In this way—by strengthening some electronic synapses and weakening others through the adjustment of input weights—these neurons implement an electronic version of STDP.

FIG. 1D is a schematic diagram of a circuit that embodies an electronic synapse, such as the electronic synapses 110, 112, 114, 116 shown in FIG. 1C. Specifically, the electronic synapse 120 in FIG. 1D includes a node 122 that couples to an axon, a node 124 that couples to a dendrite, and a memristor 126 to store data. An optional access or control device 128 (e.g., a PN diode or field effect transistor (FET) wired as a diode, or some other element with a non-linear voltage-current response) may be coupled in series with the memristor 126 to prevent cross-talk during communication of neuronal spikes on adjacent axons or dendrites and to minimize leakage and power consumption. In some embodiments, a different memory element (e.g., static random access memory (SRAM), dynamic random access memory (DRAM), enhanced dynamic random access memory (EDRAM)) is used in lieu of the memristor 126.

FIG. 1E is a schematic diagram of an electronic neuron 130. Specifically, an electronic neuron 130 comprises electronic neuron spiking logic 131 and multiple resistor-capacitor (RC) circuits 132, 134. Although only two RC circuits are shown in the electronic neuron 130 of FIG. 1E, any suitable number of RC circuits may be used. Each RC circuit includes a resistor 136 and a capacitor 138 coupled as shown. When an electronic neuron fires (i.e., issues a spike) as a result of its membrane potential exceeding the neuron's firing threshold, the neuron maintains pre-synaptic and post-synaptic STDP variables. Each of these variables is a signal that decays with a relatively long time constant that is determined based on the values of the capacitor in a different one of the RCs 132, 134. Each of these signals may be sampled by determining the voltage across a corresponding RC circuit capacitor using, e.g., a current mirror. By sampling each of the variables, the length of time between the arrival of a pre-synaptic spike and a post-synaptic action potential following the spike arrival can be determined, as can the length of time between a post-synaptic action potential and a pre-synaptic spike arrival following the action potential. As explained above, the lengths of these times are used in STDP—that is, to effect synaptic potentiation and depression by adjusting synaptic weights, and thus to facilitate neurosynaptic learning.

FIG. 1F is a block diagram of the electronic neuron spiking logic 131 of FIG. 1E. The logic 131 includes three conceptual components: a synaptic component 140, a neuronal core component 142, and a comparator component 144. Although FIG. 1F shows only one synaptic component 140, in practice, a separate synaptic component 140 is used for each synapse from which the electronic neuron receives input. Thus, in some embodiments the electronic neuron contains multiple synaptic components 140, one for each synapse from which that neuron receives input. In other embodiments, the synaptic component 140 forms a part of the synapse itself and not the electronic neuron. In either type of embodiment, the end result is the same.

Each synaptic component 140 includes an excitatory/inhibitory signal generator 146, a weight signal generator 148 associated with the corresponding synapse, and a pulse generator 150. The pulse generator 150 receives a clock signal 152 and a spike input signal 154, as well as a weight signal 151 from the weight signal generator 148. The pulse generator 150 uses its inputs to generate a weighted spike signal 158—for instance, the spike input signal 154 multiplied by the weight signal 151. The width of the weighted spike signal pulse reflects the magnitude of the weighted signal, and thus the magnitude that will contribute to or take away from the membrane potential of the electronic neuron. The weighted signal for the synapse corresponding to the synaptic component 140 is provided to the core component 142, and similar weighted signals are provided from synaptic components 140 corresponding to other synapses from which the electronic neuron receives input. For each weighted signal that the core 142 receives from a synaptic component 140, the core 142 also receives a signal 156 from the excitatory/inhibitory signal generator 146 indicating whether the weighted signal 158 is an excitatory (positive) or inhibitory (negative) signal. An excitatory signal pushes the membrane potential of the electronic neuron toward its action potential threshold, while an inhibitory signal pulls the membrane potential away from the threshold. As explained, the neurosynaptic learning process involves the adjustment of synaptic weights. Such weights can be adjusted by modifying the weight signal generator 148.

The core component 142 includes a membrane potential counter 160 and a leak-period counter 162. The membrane potential counter receives the weighted signal 158 and the excitatory/inhibitory signal 156, as well as the clock 152 and a leak signal 164 from the leak-period counter 162. The leak-period counter 162, in turn, receives only clock 152 as an input. In operation, the membrane potential counter 160 maintains a counter—initially set to zero—that is incremented when excitatory, weighted signals 158 are received from the synaptic component 140 and that is decremented when inhibitory, weighted signals 158 are received from the synaptic component 140. When no synapse pulse is applied to the core component 142, the leak period counter signal 164 causes the membrane potential counter 160 to gradually decrement at a predetermined, suitable rate. This action mimics the leak experienced in biological neurons during a period in which no excitatory or inhibitory signals are received by the neuron. The membrane potential counter 160 outputs a membrane potential signal 166 that reflects the present value of the counter 160. This membrane potential signal 166 is provided to the comparator component 144.

The comparator component 144 includes a threshold signal generator 168 and a comparator 170. The threshold generator 168 generates a threshold signal 169, which reflects the threshold at which the electronic neuron 130 generates a spike signal. The comparator 170 receives this threshold signal 169, along with the membrane potential signal 166 and the clock 152. If the membrane potential signal 166 reflects a counter value that is equal to or greater than the threshold signal 169, the comparator 170 generates a spike signal 172, which is subsequently output via an axon of the electronic neuron. As numeral 174 indicates, the spike signal is also provided to the membrane potential counter 160, which, upon receiving the spike signal, resets itself to zero.

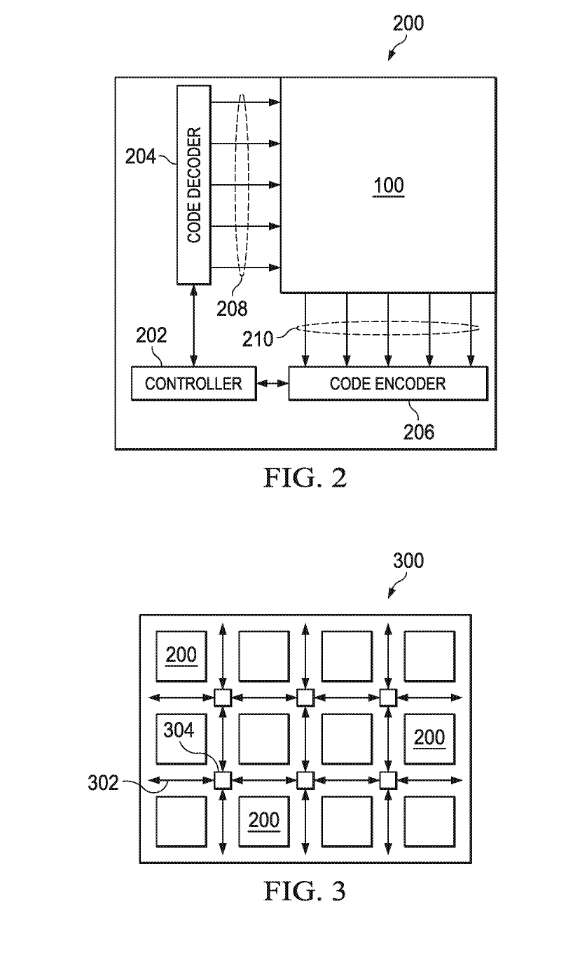

FIG. 2 is a schematic diagram of a neurosynaptic core 200 for use in a cognitive computer. The core 200 includes a neurosynaptic tile 100, a controller 202, a decoder 204, an encoder 206, inputs 208, and outputs 210. Spike events generated by electronic neurons generally take the form of data packets. These packets, which may be received from neurons on other cores external to the core 200, are decoded by the decoder 204 (e.g., to interpret and remove packet headers) and passed as inputs 208 to the neurosynaptic tile 100. Similarly, packets generated by neurons within the neurosynaptic tile 100 that are destined for neurons outside the core 200 are passed as outputs 210 to the encoder 206 for encoding (e.g., to include a header with a destination address). The controller 202 controls the decoder 204 and encoder 206.

FIG. 3 is a schematic diagram of a multi-core neurosynaptic chip 300 for use in a cognitive computer. The chip 300 includes a plurality of neurosynaptic cores 200, such as the core 200 described with respect to FIG. 2. The cores 200 couple to each other via electrical connections (e.g., conductive traces). The chip 300 may include any suitable number of cores—for example, 4,096 or more cores on a single chip, with each core containing millions of electronic synapses. The chip 300 also contains a plurality of intrachip spike routers 304 that couple to a routing fabric 302. The cores 200 communicate with each other via the routers 304 and the fabric 302, using the aforementioned encapsulated, encoded packets to facilitate routing between cores and specific neurons within the cores.

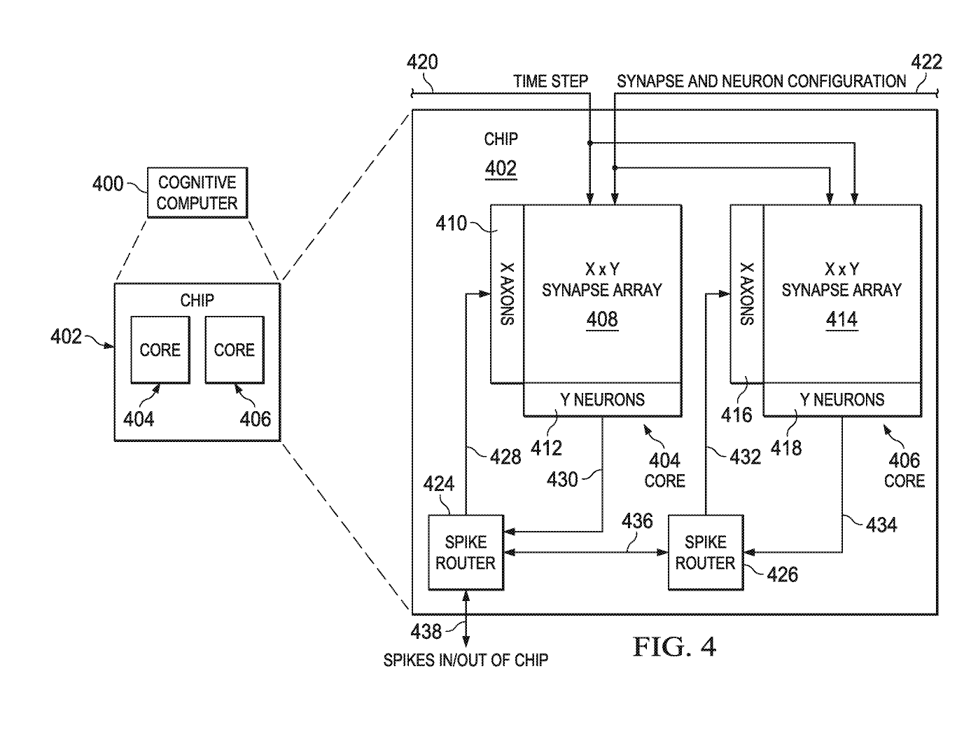

FIG. 4 is a detailed schematic diagram of a dual-core neurosynaptic chip 402 for use in a cognitive computer 400. Specifically, a cognitive computer may include any suitable number of neurosynaptic chips 402, and each of these neurosynaptic chips 402 may include any suitable number of neurosynaptic cores, as previously explained. In the example of to FIG. 4, the neurosynaptic chip 402 is a dual-core chip containing neurosynaptic cores 404, 406. The core 404 includes a synapse array 408 that includes a plurality of synapses that couple various axons 410 to dendrites. In some embodiments, axons 410 receive spikes from neurons directly coupled to the axons 410 and included on the core 404 (not specifically shown in FIG. 4, but an illustrative embodiment is shown in FIG. 1). In other embodiments, axons 410 are extensions of neurons located off of the core 404 (e.g., elsewhere on the chip 402, or on a different chip). In embodiments where the axons 410 couple directly to on-core neurons (e.g., as shown in FIG. 1), the spike router 424 provides spikes directly to the neurons' dendrites. In embodiments where the axons 410 are extensions of off-core neurons, the spike router 424 provides spikes from those neurons to the axons 410. Although a multitude of variations of such embodiments are possible, for brevity, FIG. 4 shows only an array of axons 410.

The synapse array 408 also couples to neurons 412. The neurons 412 may be a single-row, multiple-column array of neurons, or, alternatively, the neurons 412 may be a multiple-row-, multiple-column array of neurons. In either case, dendrites of the neurons 412 couple to axons 410 in the synapse array 408, thus facilitating the transfer of spikes from the axons 410 to the neurons 412 via dendrites in the synapse array 408. The spike router 424 receives spikes from off-core sources, such as the core 406 or off-chip neurons. The spike router 424 uses spike packet headers to route the spikes to the appropriate neurons 412 (or, in some embodiments, on-core neurons directly coupled to axons 410). In either case, bus 428 provides data communication between the spike router 424 and the core 404. Similarly, neurons 412 output spikes on their axons and bus 430 provides the spikes to the spike router 424. The core 406 is similar or identical to the core 404. Specifically, the core 406 contains axons 416, neurons 418, and a synapse array 414. The axons 416 couple to a spike router 426 via bus 432, and neurons 418 couple to the spike router 426 via bus 434. The functionality of the core 406 is similar or identical to that of the core 404 and thus is not described. A bus 436 couples the spike routers 424, 426 to facilitate spike routing between the cores 404, 406. A bus 438 facilitates the communication of spikes on and off of the chip 402. The architectures shown in FIGS. 1-4 (e.g., the TRUENORTH® architecture by IBM®) are non-limiting; other architectural configurations are contemplated and included within the scope of the disclosure.

Various types of software may be written for use in cognitive computers. One programming methodology is described below, but the scope of disclosure is not limited to this particular methodology. Any suitable, known software architecture for programming neurosynaptic processing logic is contemplated and intended to fall within the scope of the disclosure. The software architecture described herein entails the creation and use of programs that are complete specifications of networks of neurosynaptic cores, along with their external inputs and outputs. As the number of cores grows, creating a program that completely specifies the network of electronic neurons, axons, dendrites, synapses, spike routers, buses, etc. becomes increasingly difficult. Accordingly, a modular approach may be used, in which a network of cores and/or neurons encapsulates multiple sub-networks of cores and/or neurons; each of the sub-networks encapsulates additional sub-networks of cores and/or neurons, and so forth. In some embodiments, the CORELET® programming language, library and development environment by IBM® may be used to develop such modular programs.

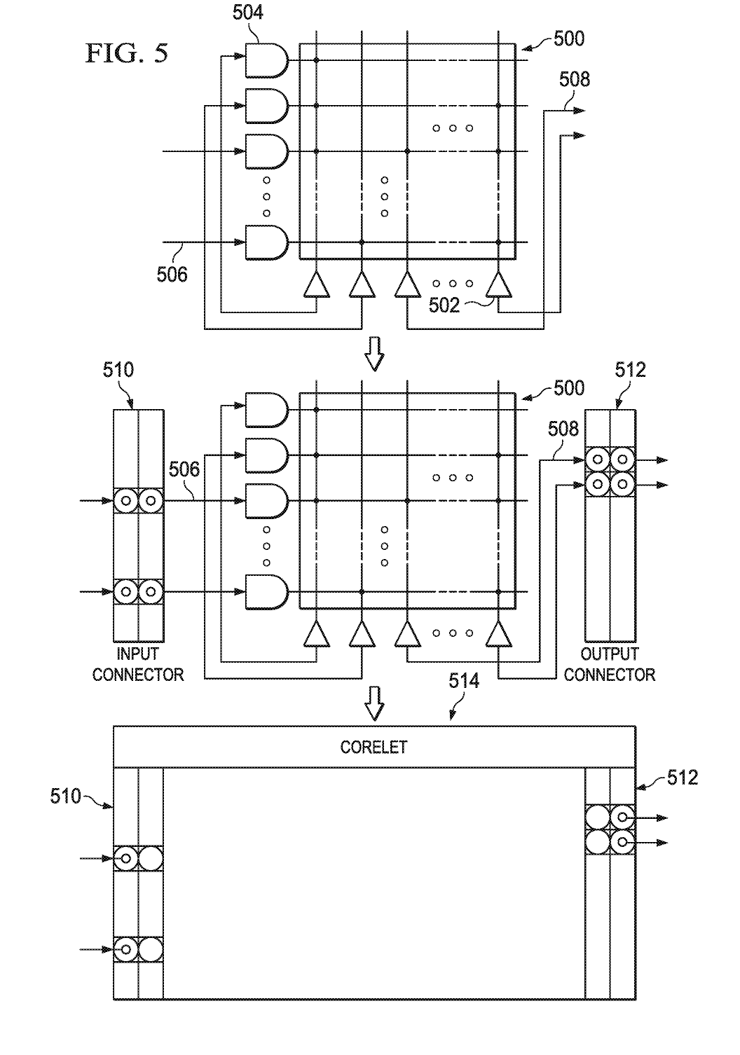

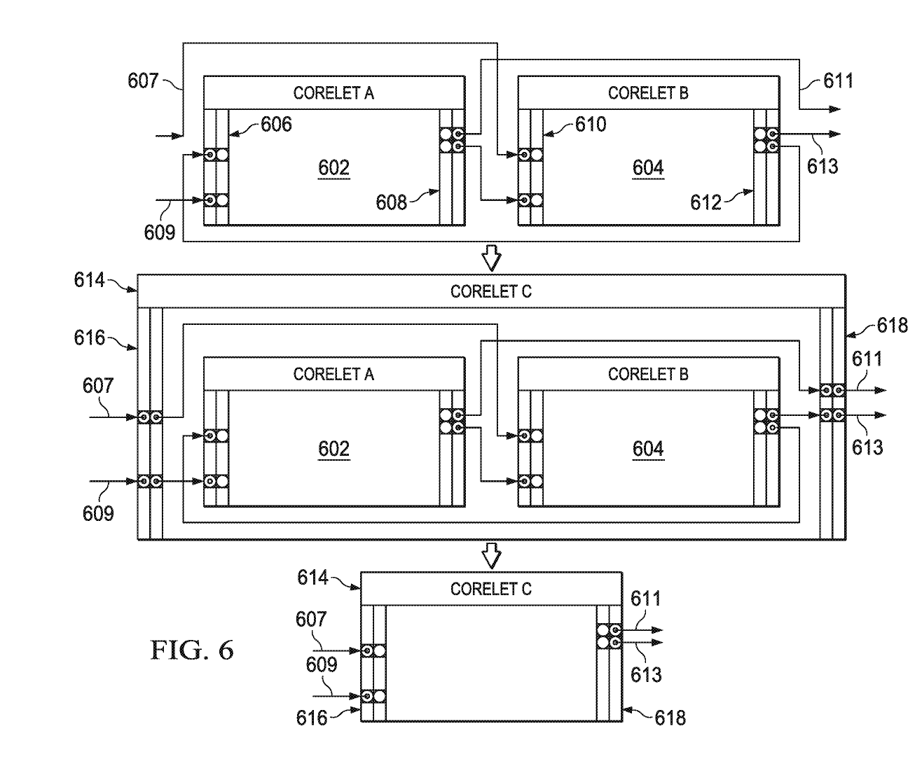

FIGS. 5 and 6 are conceptual diagrams illustrating the modular nature of the CORELET® programming architecture. FIG. 5 contains three panels. The first panel illustrates a neurosynaptic tile 500 containing a plurality of neurons 502 and axons 504, similar to the neurosynaptic architecture shown in FIG. 4. As shown, some of the neurons' outputs couple to the axons' inputs. However, inputs to other axons 504 are received from outside the tile 500, as numeral 506 indicates. Similarly, outputs from other neurons 502 are provided outside of the tile 500, as numeral 508 indicates. The second panel in FIG. 5 illustrates the initial step in the encapsulation of a tile into a corelet—that is, an abstraction that represents a program (for a neurosynaptic processing logic) that only exposes external inputs and outputs while encapsulating all other details into a “black box.” Thus, as shown in the second panel, the only inputs to the tile 500 are inputs 506 to some of the axons 504, and the only outputs from the tile 500 are outputs 508 from some of the neurons 502. The inputs 506 couple to an input connector 510, and the outputs couple to an output connector 512. The third panel in FIG. 5 shows the completed corelet 514, with only the input connector 510 and output connector 512 being exposed, and with the remainder of the tile 500 having been encapsulated into the corelet 514. The completed corelet 514 constitutes a single building block of the CORELET® modular architecture; the corelet 514 may be grouped with one or more other corelets to form a larger corelet; in turn, that larger corelet may be grouped with one or more other larger corelets to form an even larger corelet, and so forth.

FIG. 6 includes three panels illustrating such encapsulation of multiple sub-corelets into a larger corelet. Specifically, the first panel includes corelets 602 and 604. Corelet 602 includes an input connector 606 and output connector 608. The remainder of the contents of the corelet 602 do not couple to circuitry outside of the corelet 602 and thus are not specifically shown as being coupled to the input connector 606 or the output connector 608. Similarly, corelet 604 includes an input connector 610 and an output connector 612. Certain inputs to and outputs from the corelets 602, 604 couple to each other, while other such inputs and outputs do not (i.e., inputs 607, 609 are not received from either corelet 602, 604, and outputs 611, 613 are not provided to either corelet 602 or 604). Thus, as shown in the second and third panels of FIG. 6, when the corelets 602, 604 are grouped into a single, larger corelet 614, only inputs 607, 609 are exposed on the input connector 616, and only outputs 611, 613 are exposed on the output connector 618. The remaining contents of the corelet 614 are encapsulated. As explained, one purpose of encapsulating neurosynaptic processing logic into corelets and sub-corelets is to organize the processing logic in a modular way that facilitates the creation of CORELET® programs, since such programs are complete specifications of networks of neurosynaptic cores. Although FIGS. 5 and 6 demonstrate the modular nature of the CORELET® software architecture, the CORELET® syntax itself is known and is not described here. Cognitive computing software systems other than CORELET® also may be used in conjunction with the hardware described herein or with any other suitable cognitive computing hardware. All such variations and combinations of potentially applicable cognitive computing hardware and software are contemplated and may be used to implement the oilfield operations enhancement techniques described herein.

The remainder of this disclosure describes the use of hardware and software cognitive computing technology to facilitate the enhancement of oilfield operations. As explained above, any suitable cognitive computing hardware or software technology may be used to implement such techniques. This cognitive computing technology may include none, some or all of the hardware and software architectures described above. For example, the oilfield operations enhancement techniques described below may be implemented using the CORELET® programming language or any other software language used in conjunctive with cognitive computers. The foregoing architectural descriptions, however, are non-limiting. Other hardware and software architectures may be used in lieu of, or to complement, any of the foregoing technologies. Any and all such variations are included within the scope of the disclosure.

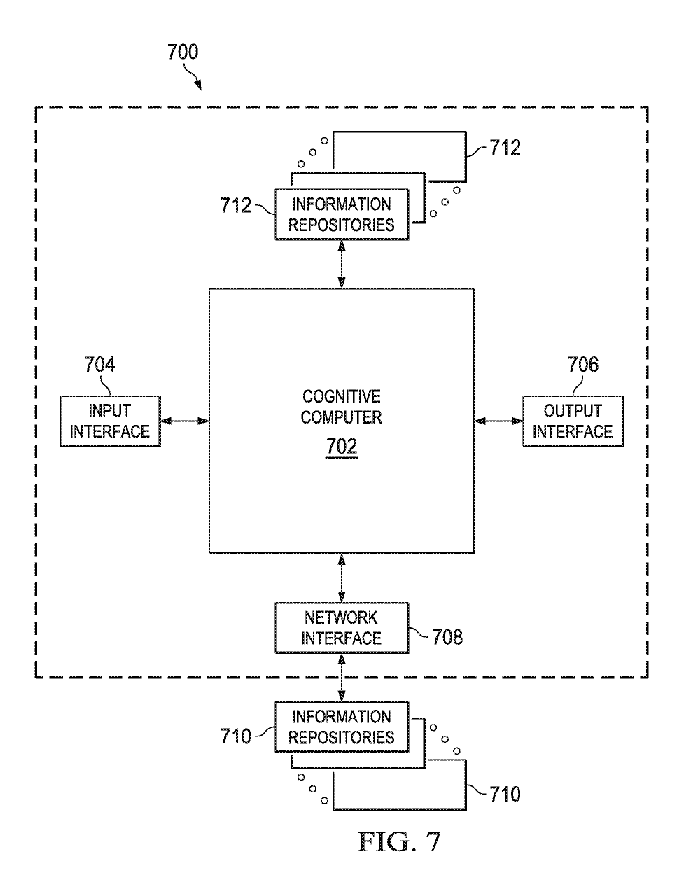

FIG. 7 is a block diagram of a cognitive computing system 700 that has access to multiple information repositories. Specifically, the cognitive computing system 700 includes a cognitive computer 702 (i.e., any suitable computer that includes neurosynaptic processing logic and cognitive algorithm-based software, such as those described above) coupled to an input interface 704, an output interface 706, a network interface 708 and one or more local information repositories 712. In at least some embodiments, the input interface 704 is any suitable input device(s), such as a keyboard, mouse, touch screen, microphone, video camera, or one or more wearable devices (e.g., augmented reality device such as GOOGLE) GLASS®). Other input devices are contemplated. The output interface 706 may include one or more of a display and an audio output device. Other output devices are contemplated. The network interface 708 is, for example, a network adapter or other suitable interface logic that enables communication between the cognitive computer 702 and any device not directly coupled to the cognitive computer 702. The local information repositories 712 include, without limitation, thumb drives, compact discs, Bluetooth devices, and any other device that can couple directly to the cognitive computer 702 such as by universal serial bus (USB) cable or high definition multimedia interface (HDMI) cable.

The cognitive computer 702 communicates with any number of remote information repositories 710 via the network interface 708. The quantity and types of such information repositories 710 may vary widely, and may include, without limitation, other cognitive computers; databases; distributed databases; sources that provide real-time data pertaining to oil and gas operations, such as drilling, fracturing, cementing, or seismic operations; servers; other personal computers; mobile phones and smart phones; websites and generally any resource(s) available via the Internet, World Wide Web, or a local network connection such as a virtual private network (VPN); cloud-based storage; libraries; and company-specific, proprietary, or confidential data. Any other suitable source of information with which the cognitive computer 702 can communicate is included within the scope of disclosure as a potential information repository 710. The software stored on the cognitive computer 702 is probabilistic (i.e., non-deterministic) in nature, meaning that its behavior is guided by probabilistic determinations as to possible events that may occur in the drilling environment being analyzed.

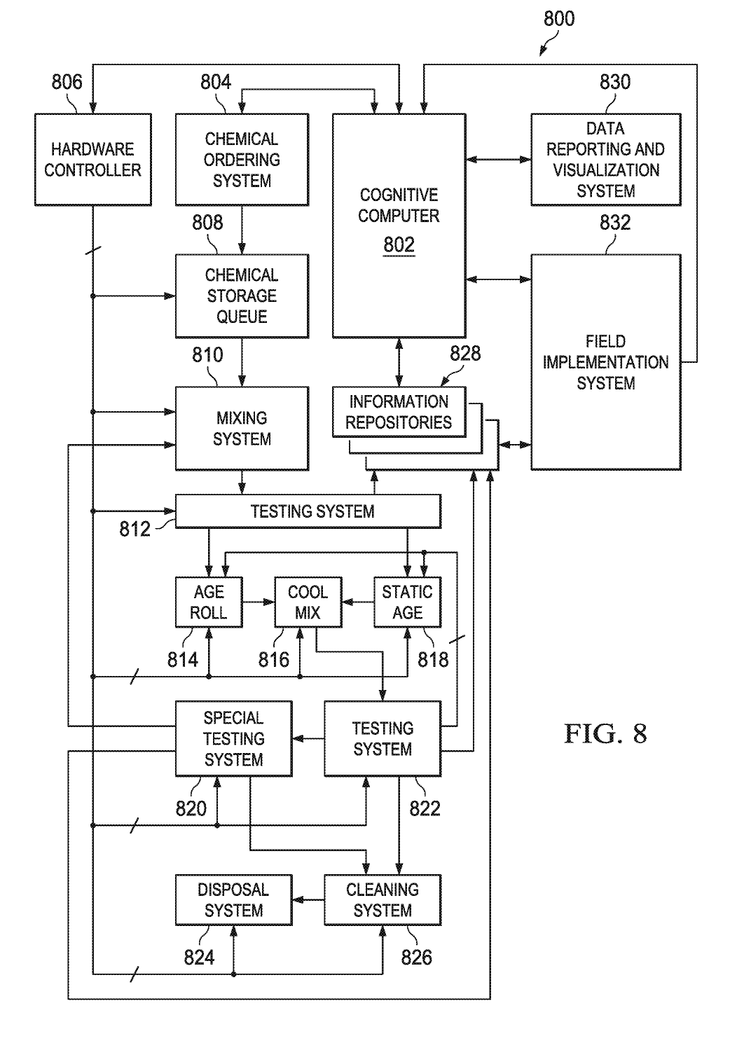

FIG. 8 is a block diagram of a cognitive computing system controlling a chemical production system and a field implementation system. A system 800 generally includes a cognitive computer 802, a chemical ordering system 804, a chemical production hardware controller 806, a chemical storage queue 808, a mixing system 810, a testing system 812, an age rolling system 814, a cool mixing system 816, a static aging system 818, a special testing system 820 and a testing system 822, a disposal system 824, and a cleaning system 826. The system 800 further includes information repositories 828 comprising various resources and comprising a knowledge corpus local to the cognitive computer 802, a data reporting and visualization system 830 (e.g., an output interface, such as a display panel), and a field implementation system 832 (e.g., a drilling environment in which chemical formulations are deployed). The systems 804, 808, 810, 812, 814, 816, 818, 820, 822, 824 and 826 may collectively be referred to as the chemical production system, although in some embodiments the chemical production system may not include the systems 824 and/or 826.

In operation, the cognitive computer 802 receives target and constraint information—for instance, from a human user or from another cognitive computer. The target information specifies the goal of the chemical formulation that is to be designed and produced, and the constraint information specifies various criteria that the chemical formulation must meet—for example and without limitation, criteria regarding price, production time, physical properties, chemical properties, and the like. The cognitive computer 802 uses the target and constraint information to identify helpful resources on the one or more information repositories 828. In some embodiments, the cognitive computer 802 may identify such resources by reviewing the resources it accessed when designing prior chemical formulations and the degree to which they helped, or by using resource selection algorithms that it received from, e.g., a user or other cognitive computer. The scope of disclosure is not limited to these specific techniques for identifying helpful resources when designing chemical formulations.

Based on the identified resources, the target(s), the constraint(s), and any other information that the cognitive computer 802 may consider (e.g., training sessions and information it has learned on its own from past experiences), the cognitive computer 802 designs the first chemical formulation in an attempt to achieve the target(s) while honoring the constraint(s). The cognitive computer 802 designs the first chemical formulation (and any subsequent versions of the first chemical formulation) using the neurosynaptic architecture described above—that is, probabilistically, intelligently and with minimal or no human assistance.

After it has designed the first chemical formulation, the cognitive computer 802 causes the first chemical formulation to be produced. To produce the first chemical formulation, the cognitive computer 802 uses a chemical ordering system 804—such as corporate buyer software—to procure the chemicals and other materials necessary to produce the first chemical formulation. The cognitive computer 802 may have been trained to procure these chemicals and other materials from preferred vendors, and the computer 802 may adjust shipping preferences based on the urgency of its chemical formulation project. The procured chemicals and other materials are subsequently stored in a chemical storage queue 808.

The cognitive computer 802 couples to the hardware controller 806 and controls the components 808-826 through the hardware controller 806 (i.e., the cognitive computer 802 has partial or complete control of the hardware controller 806). The hardware controller 806 causes the mixing system 810 to combine and react the appropriate chemicals and other materials from the chemical storage queue 808 as appropriate and in accordance with the design for the first chemical formulation. The mixing system 810 may contain and/or have access to any number of hardware and/or software components—e.g., centrifuges; beakers, test tubes and flasks; microscopes; Bunsen burners; burets; tongs; pipets, and the like, as well as robotic arms to perform the experiments. In some embodiments, the cognitive computer 802 may command one or more human assistants to perform certain tasks, but in most or all such cases, the humans are not involved in designing the chemical formulations. The mixing performed by the mixing system 810 preferably is shear-, time- and temperature-controlled in accordance with the specifications of the cognitive computer 802.

After the mixing system 810 has produced the first chemical formulation, the hardware controller 806 uses the testing system 812 to test the first chemical formulation. The testing system 812 may contain any suitable testing equipment and, in at least some embodiments, shares equipment with the mixing system 810. The testing system 812 may test the first chemical formulation to determine any number of parameters, including, but not limited to, rheology, density, filtration, sag, pH, conductivity, time-dependent rheology; salinity; relative mass of one or more components (water, oil, etc.); emulsion stability; dielectric constants, etc. The results of this testing are provided to the cognitive computer 802 and are stored in one or more of the information repositories 828.

After the testing is performed, the cognitive computer 802 uses the results and various resources, as well as its prior training and any relevant prior observations it has made, to condition the first chemical formulation. Specifically, the hardware controller 806 causes the age roll system 814 to age roll, or “hot roll,” the first chemical formulation. Hot rolling includes heating the first chemical formulation so that it is conditioned to a different environment to be tested. Alternatively, the hardware controller 806 causes the static aging system 818 to condition the first chemical formulation for static aging. Static and dynamic aging tests are performed to test the long-term performance of fluids after exposure to heat with or without shear. In either case, the first chemical formulation is then provided to a cool mix system 816 to cool the formulation down to a temperature specified by the cognitive computer 802.

The conditioned first chemical formulation is subsequently provided to the testing system 822, where the conditioned first chemical formulation is tested to determine any number of parameters. Illustrative tests/testing parameters may include static aging; rheology; density; filtration; sag; pH; conductivity; time-dependent rheology; salinity; relative mass of one or more components (oil, water, etc.); and the like. The scope of disclosure is not limited to these parameters, however, and the specific parameters that the testing system 822 tests are determined by the cognitive computer 802. The results of this test, like the results of most or all tests, are stored in one or more of the information repositories 828.

In some embodiments, after the testing system 822 has performed its tests, the first chemical formulation may be re-conditioned by one or more of the components 814, 816, 818 as the cognitive computer 802 deems suitable. Alternatively or in addition, in situations where time constraints are less stringent, the first chemical formulation may undergo additional testing by the special testing system 820. Tests performed by the special testing system 820 are generally those tests that were not performed by the testing system 822 due to time constraints but that the cognitive computer 802 determines may have additional value—for example, determining corrosion, lubricity, long-term sag testing, toxicity, etc. The specific parameters tested in the testing system 822 and the special testing system 820 are determined by the cognitive computer 802. The results of the special testing performed by the system 820 are stored in one or more information repositories 828. The results also are provided to the hardware controller 806 and/or cognitive computer 802 to help evaluate the performance of the mixing system 810. In some embodiments, after testing is performed by the testing system 822 or the special testing system 820, no additional work is done on the first chemical formulation and the equipment used to perform the chemistry experiment are cleaned by the cleaning system 826 (e.g., using robotic arms controlled by the cognitive computer 802) and waste is appropriately disposed by the disposal system 824 (e.g., again using robotic arms or similar technology, controlled by the cognitive computer 802).

The cognitive computer 802 evaluates all experimental data collected and stored in the information repositories 828. Such evaluation may include the use of any number of resources, including models, simulations, equations/formulas, and the like so that the cognitive computer 802 may learn as much information as possible from the experimentation on the first chemical formulation. Because the cognitive computer 802 is a neurosynaptic machine, it performs such analyses intelligently, probabilistically and with minimal or no human assistance. The cognitive computer 802 learns from the experiment(s) and tests performed on the first chemical formulation. Based on this learning, the cognitive computer 802 may take any of a variety of actions. In some embodiments, the cognitive computer 802 uses what it learned when experimenting with the first chemical formulation to design a second chemical formulation, and the experimentation process described above is repeated for the second chemical formulation. Because it is designed with the benefit of testing results on the first chemical formulation, the second chemical formulation typically will more closely achieve the target(s) and will better honor the constraint(s). For example, if the target(s) and/or constraint(s) are objective, specific parameters, the second chemical formulation may more closely meet such parameters than the first chemical formulation. If the target(s) and/or constraint(s) are more subjective in nature, the second chemical formulation will still more closely meet such subjective goals (as determined, e.g., by the user of the cognitive computer) than the first chemical formulation.

Alternatively or in addition, in some embodiments the cognitive computer 802 generates a field implementation recommendation. This recommendation specifies a plan under which the first chemical formulation (or a variant thereof) is implemented in a field scenario—for example, in a drilling operation. The recommendation, along with all pertinent data, may be presented to a user or other cognitive computer via, e.g., the data reporting and visualization system 830. The scope of disclosure is not limited to providing any particular types of information via the data reporting and visualization system 830, however, and the system 830 may be used to provide users and/or other cognitive computers with any and all types of information described herein.

If a human user or other cognitive computer determines that the field implementation recommendation should be approved, or if the cognitive computer 802 unilaterally determines that it will execute the field implementation recommendation, then the field implementation system 832 is used to execute the recommendation. For instance, in the case of a first chemical formulation that is a drilling fluid additive, the cognitive computer 802 may cause the field implementation system 832 to modify the drilling fluid in a drilling well with the additive. The field implementation system 832 gathers data pertaining to the implementation and records the data to the information repositories 828. Such data may include, for instance, test results associated with the field implementation operation. The cognitive computer 802 is subsequently able to access such information from the information repositories 828 when designing the second chemical formulation. The field implementation system 832 is generally any hardware, software, and/or human personnel that may be used to implement a particular chemical formulation in a “real-life” environment.

In some embodiments, the cognitive computer 802 may play a more passive role and may keep unilateral actions to a minimum. In such embodiments, the cognitive computer 802 may, for example, provide the user or other cognitive computers with one or more proposed courses of action after experimentation and analysis of the first chemical formulation is complete. Thus, for instance, the cognitive computer 802 may offer the user or other cognitive computer the option of designing a second chemical formulation, generating a field implementation recommendation, or pursuing some other course of action. In such cases, the cognitive computer 802 would act only after the user or other cognitive computer has selected one of the proposed courses of action.

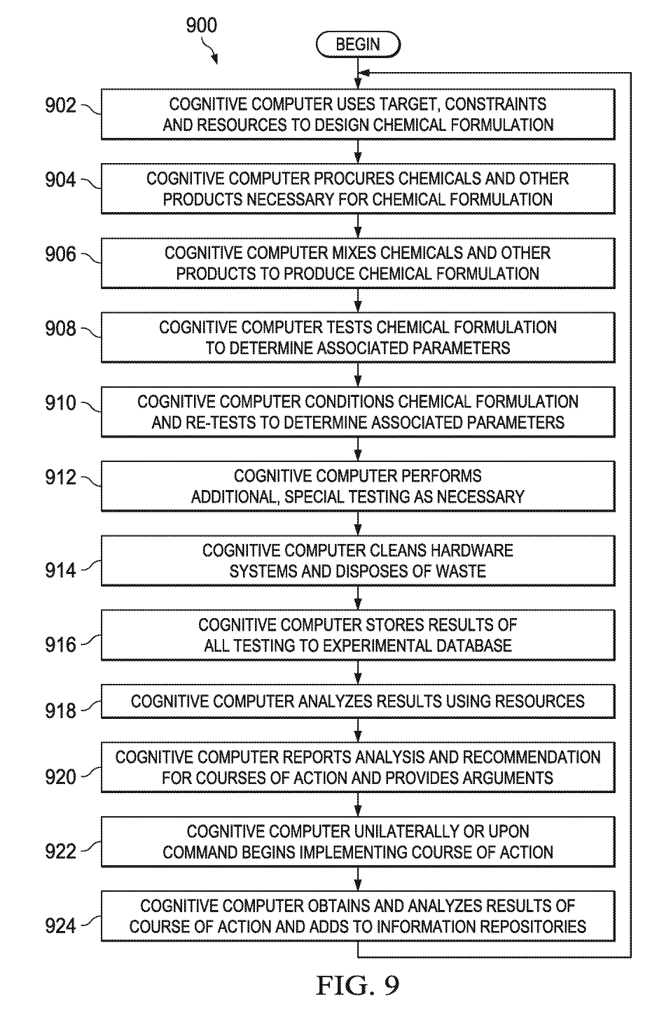

FIG. 9 is a flow diagram of a method 900 used to produce and enhance chemical formulations. The method 900 begins with the cognitive computer using target(s), constraint(s) and resources to design a chemical formulation (step 902). The cognitive computer procures chemicals and other materials necessary to produce and test the chemical formulation (step 904). The computer identifies these chemicals and materials using the vast resources to which it has access in addition to the cognitive computer's own learning from training and prior experiences. The method 900 then comprises the cognitive computer combining the chemicals and/or materials in accordance with its design to produce the chemical formulation (step 906). The cognitive computer tests the chemical formulation to determine various parameters associated with that formulation (step 908). Non-limiting examples of such tested parameters are given above and may include rheology, density, filtration, sag, pH, physical parameters, conductivity, and the like. The cognitive computer subsequently conditions the chemical formulation and then re-tests the conditioned formulation to determine various parameters—for instance, those parameters determined during the testing in step 908 (step 910). Such conditioning may include, without limitation, hot-rolling, static aging and cool mixing. The cognitive computer may perform special, additional testing as necessary—for example, to identify corrosion, lubricity or toxicity (step 912).

Once experimentation is complete, the cognitive computer cleans the experimentation equipment and disposes of waste—for instance, through the use of robotic arms, by issuing commands to a human assistant, or a combination thereof (step 914). The results of all testing mentioned above may be stored for future use in one or more information repositories (e.g., as resources) (step 916). The cognitive computer then analyzes the testing results using its resources, prior training and learning, and any and all other information to which it may have access (step 918). This analysis, as with all or nearly all of the cognitive computer's actions, is performed probabilistically, intelligently and with minimal or no human assistance.

The cognitive computer subsequently reports its analysis to a user or other cognitive computer (e.g., via an interface) (step 920). Such reporting may take the form of, for instance, one or more proposed courses of action that include the option of designing and testing a new chemical formulation based on the experimentation and testing just performed, or that include a field implementation recommendation such as that described above. As part of this reporting, the cognitive computer may provide arguments supporting its proposed course(s) of action. It may also discuss these items with the user or other cognitive computer—for example, in a question-and-answer format or a debate format. The cognitive computer may unilaterally or upon command implement one or more proposed courses of action, such as a field implementation recommendation (step 922). The cognitive computer then obtains and analyzes results of the implemented course(s) of action (e.g., the field implementation) and adds such results to one or more information repositories (step 924). Because the disclosed design and experimentation process is iterative, the method then may begin again at step 902. The foregoing steps may be modified in any suitable way, including the addition, deletion or rearrangement of steps.

Numerous other variations and modifications will become apparent to those skilled in the art once the above disclosure is fully appreciated. It is intended that the following claims be interpreted to embrace all such variations, modifications and equivalents. In addition, the term “or” should be interpreted in an inclusive sense.

At least some embodiments are directed to a cognitive computing system for producing chemical formulations, comprising: neurosynaptic processing logic; and one or more information repositories accessible to the neurosynaptic processing logic, said one or more repositories storing resources, wherein the neurosynaptic processing logic determines a first chemical formulation to achieve a target and to satisfy one or more constraints, produces and tests said first chemical formulation, and analyzes the results of the test using said resources to determine a second chemical formulation, wherein the second chemical formulation more closely achieves the target and satisfies the one or more constraints than the first chemical formulation. These embodiments may be supplemented using one or more of the following concepts, in any order and in any combination: wherein, to produce the first chemical formulation, the neurosynaptic processing logic causes a chemical production system to procure one or more chemicals and to combine the one or more chemicals; wherein the neurosynaptic processing logic causes the chemical production system to combine the one or more chemicals in a shear, time- and temperature-controlled environment; wherein the neurosynaptic processing logic tests the first chemical formulation to determine one or more parameters selected from the group consisting of: rheology, density, filtration, sag, pH, conductivity, and emulsion stability; wherein the neurosynaptic processing logic causes a chemical production system to condition the first chemical formulation; wherein the chemical production system conditions the first chemical formulation to produce a conditioned first chemical formulation by hot rolling said first chemical formulation, static aging the first chemical formulation, cool mixing the first chemical formulation, or a combination thereof; wherein the neurosynaptic processing logic tests the conditioned first chemical formulation to determine one or more parameters selected from the group consisting of: rheology, density, filtration, sag, pH, conductivity, and emulsion stability; wherein the neurosynaptic processing logic tests the conditioned first chemical formulation to determine one or more additional parameters selected from the group consisting of: corrosion, lubricity and toxicity; wherein the neurosynaptic processing logic determines said second chemical formulation based on results of said tests; wherein, based on said analysis, the neurosynaptic processing logic provides a field implementation recommendation via an output interface; wherein the neurosynaptic processing logic provides and responds to arguments about said recommendation via said output interface; wherein the neurosynaptic processing logic unilaterally or upon command implements the field implementation recommendation; wherein the neurosynaptic processing logic performs a test after implementing said recommendation and stores results of said test in said one or more information repositories as a resource; wherein the neurosynaptic processing logic determines said second chemical formulation based on results of said tests.

At least some embodiments are directed to a cognitive computing system for producing chemical formulations, comprising: neurosynaptic processing logic including multiple electronic neurons operating in parallel; input and output interfaces coupled to the neurosynaptic processing logic; and one or more information repositories accessible to the neurosynaptic processing logic and comprising resources, wherein, via the input and output interfaces, the neurosynaptic processing logic: procures one or more materials needed to produce a chemical formulation; combines the one or more materials to produce said chemical formulation; performs a first test to determine multiple parameters of the chemical formulation and stores results of said first test in the one or more information repositories; conditions the chemical formulation to produce a conditioned chemical formulation; performs one or more additional tests to determine a plurality of parameters of the conditioned chemical formulation and stores results of said one or more additional tests in the one or more information repositories; and analyzes the results of the first test and the one or more additional tests to produce a proposed course of action. These embodiments may be supplemented using one or more of the following concepts, in any order and in any combination: wherein the proposed course of action is selected from the group consisting of: modification of the chemical formulation to produce a next chemical formulation; and field implementation of the chemical formulation; wherein the neurosynaptic processing logic uses results of said field implementation to determine said next chemical formulation.

At least some embodiments are directed to a method for producing chemical formulations, comprising: using a neurosynaptic processing logic to combine one or more materials to produce a first chemical formulation; using the neurosynaptic processing logic to test the first chemical formulation and to analyze results of said test; and using the neurosynaptic processing logic to probabilistically produce a second chemical formulation based on said results, wherein the second chemical formulation more closely achieves a predetermined target than the first chemical formulation. These embodiments may be supplemented using one or more of the following concepts, in any order and in any combination: wherein the neurosynaptic processing logic performs said using steps without human input; wherein the neurosynaptic processing logic performs a field implementation of said first chemical formulation and uses results of said field implementation to produce the second chemical formulation.

1. A cognitive computing system for producing chemical formulations, comprising:
neurosynaptic processing logic; and
one or more information repositories accessible to the neurosynaptic processing logic, said one or more repositories storing resources,
wherein the neurosynaptic processing logic determines a first chemical formulation to achieve a target and to satisfy one or more constraints, produces and tests said first chemical formulation, and analyzes the results of the test using said resources to determine a second chemical formulation,
wherein the second chemical formulation more closely achieves the target and satisfies the one or more constraints than the first chemical formulation.

2. The cognitive computing system of claim 1, wherein, to produce the first chemical formulation, the neurosynaptic processing logic causes a chemical production system to procure one or more chemicals and to combine the one or more chemicals.

3. The cognitive computing system of claim 2, wherein the neurosynaptic processing logic causes the chemical production system to combine the one or more chemicals in a shear, time- and temperature-controlled environment.

4. The cognitive computing system of claim 1, wherein the neurosynaptic processing logic tests the first chemical formulation to determine one or more parameters selected from the group consisting of: rheology, density, filtration, sag, pH, conductivity, emulsion stability, time-dependent rheology, salinity, and relative mass of one or more components of the first chemical formulation.

5. The cognitive computing system of claim 1, wherein the neurosynaptic processing logic causes a chemical production system to condition the first chemical formulation.

6. The cognitive computing system of claim 5, wherein the chemical production system conditions the first chemical formulation to produce a conditioned first chemical formulation by hot rolling said first chemical formulation, preparing the first chemical formulation for static aging, cool mixing the first chemical formulation, or a combination thereof.

7. The cognitive computing system of claim 6, wherein the neurosynaptic processing logic tests the conditioned first chemical formulation to determine one or more parameters selected from the group consisting of: rheology, density, filtration, sag, pH, conductivity, emulsion stability, time-dependent rheology, salinity, and relative mass of one or more components of the conditioned first chemical formulation.

8. The cognitive computing system of claim 7, wherein the neurosynaptic processing logic tests the conditioned first chemical formulation to determine one or more additional parameters selected from the group consisting of: corrosion, lubricity and toxicity.

9. The cognitive computing system of claim 8, wherein the neurosynaptic processing logic determines said second chemical formulation based on results of said tests.

10. The cognitive computing system of claim 1, wherein, based on said analysis, the neurosynaptic processing logic provides a field implementation recommendation via an output interface.

11. The cognitive computing system of claim 10, wherein the neurosynaptic processing logic provides and responds to arguments about said recommendation via said output interface.

12. The cognitive computing system of claim 10, wherein the neurosynaptic processing to logic unilaterally or upon command implements the field implementation recommendation.

13. The cognitive computing system of claim 12, wherein the neurosynaptic processing logic performs a test after implementing said recommendation and stores results of said test in said one or more information repositories as a resource.

14. The cognitive computing system of claim 13, wherein the neurosynaptic processing logic determines said second chemical formulation based on results of said tests.

15. A cognitive computing system for producing chemical formulations, comprising:
neurosynaptic processing logic including multiple electronic neurons operating in parallel;
input and output interfaces coupled to the neurosynaptic processing logic; and
one or more information repositories accessible to the neurosynaptic processing logic and comprising resources,
wherein, via the input and output interfaces, the neurosynaptic processing logic:
procures one or more materials needed to produce a chemical formulation;
combines the one or more materials to produce said chemical formulation;
performs a first test to determine multiple parameters of the chemical formulation and stores results of said first test in the one or more information repositories;
conditions the chemical formulation to produce a conditioned chemical formulation;
performs one or more additional tests to determine a plurality of parameters of the conditioned chemical formulation and stores results of said one or more additional tests in the one or more information repositories; and
analyzes the results of the first test and the one or more additional tests to produce a proposed course of action.

16. The cognitive computing system of claim 15, wherein the proposed course of action is selected from the group consisting of: modification of the chemical formulation to produce a next chemical formulation; and field implementation of the chemical formulation.

17. The cognitive computing system of claim 16, wherein the neurosynaptic processing logic uses results of said field implementation to determine said next chemical formulation.

18. A method for producing chemical formulations, comprising:
using a neurosynaptic processing logic to combine one or more materials to produce a first chemical formulation;
using the neurosynaptic processing logic to test the first chemical formulation and to analyze results of said test; and
using the neurosynaptic processing logic to probabilistically produce a second chemical formulation based on said results,
wherein the second chemical formulation more closely achieves a predetermined target than the first chemical formulation.

19. The method of claim 18, wherein the neurosynaptic processing logic performs said using steps without human input.

20. The method of claim 18, wherein the neurosynaptic processing logic performs a field implementation of said first chemical formulation and uses results of said field implementation to produce the second chemical formulation.
